(19) United States
(12) Patent Application Publication
(10) Pub. No.: US 2025/0350910 A1
(43) Pub. Date: Nov. 13, 2025

(54) METHOD FOR CONDUCTING RADIOFREQUENCY SENSING INVOLVING AT LEAST A RADIOFREQUENCY SENSING STATION AS PART OF A MOBILE COMMUNICATION NETWORK

(71) Applicant: Deutsche Telekom AG, Bonn (DE)

(72) Inventor: Vasil ALEKSIEV, Vienna (AT)

(21) Appl. No.: 18/993,022

(22) PCT Filed: Aug. 9, 2023
(86) PCT No.: PCT/EP2023/072090

§ 371 Date: Jan. 10, 2025

(30) Foreign Application Priority Data
Aug. 12, 2022 (EP) 22190177.0

(51) Int. Cl. H04W 4/38; H04W 8/16; H04W 64/00

(52) U.S. Cl. CPC H04W 4/38; H04W 8/16; H04W 64/00

(57) ABSTRACT

A method for conducting radiofrequency sensing involving at least a radiofrequency sensing station as part of a mobile communication network includes: obtaining, by the radiofrequency sensing station, a sensing-related indication, wherein the sensing-related indication indicates whether the radiofrequency sensing station is allowed to conduct sensing or to activate the radiofrequency sensing functionality at its present location; and based on the sensing-related indication, conducting, by the radiofrequency sensing station radiofrequency sensing, wherein conducting the radiofrequency sensing comprises transmitting a radiofrequency sensing signal and/or receiving a radiofrequency sensing reception signal.

### CROSS-REFERENCE TO PRIOR APPLICATIONS

This application is a U.S. National Phase application under 35 U.S.C. § 371 of International Application No. PCT/EP2023/072090, filed on Aug. 9, 2023, and claims benefit to European Patent Application No. EP 22190177.0, filed on Aug. 12, 2022. The International Application was published in English on Feb. 15, 2024 as WO 2024/033434 A1 under PCT Article 21(2).

### FIELD

The present invention relates a method for conducting radiofrequency sensing involving at least a radiofrequency sensing station as part of a mobile communication network, wherein the radiofrequency sensing station is able to activate a radiofrequency sensing functionality and conduct radiofrequency sensing.

Additionally, the present invention relates to a system or a mobile communication network for conducting radiofrequency sensing involving at least a radiofrequency sensing station as part of the mobile communication network, wherein the radiofrequency sensing station is able to be operated such as to activate a radiofrequency sensing functionality and conduct radiofrequency sensing.

Furthermore, the present invention relates to a radiofrequency sensing station being or corresponding to a user equipment in a system or in a mobile communication network.

Furthermore, the present invention relates to a sensing service node in a system or in a mobile communication network, or as a part thereof.

Furthermore, the present invention relates to a program and to a computer-readable medium for conducting radiofrequency sensing.

### BACKGROUND

Mobile communication networks such as public land mobile networks are typically realized as cellular mobile communication networks, i.e. comprising (or using or being associated or assigned to a radio access network comprising) radio cells. Such cellular systems are known conforming to different mobile communication standards or radio access technologies, like 2G/3G/4G/5G/6G radio access technologies (referring to the different generations of radio access technologies) and typically comprise (or consist of) cells (or radio cells) of one or a plurality of the respective radio access technology/radio access technologies, which are typically organized throughout a country (or a part of or a region within a country) in a repeating pattern of (radio) cells (and associated base station entities) which belong to (or are used by or associated or assigned to) a mobile network operator (MNO).

Via realizing sensing capabilities in such communication networks, primarily via one or a plurality of radiofrequency sensing stations generating and transmitting radiofrequency sensing signals and/or via such radiofrequency sensing stations receiving radiofrequency sensing reception signals, it is possible to obtain information regarding either transmission channel properties between different stations, e.g. between base station entities and/or between user equipments, and/or regarding objects from where such radiofrequency sensing signals are reflected.

Even though such sensing capabilities are able to procure further information regarding transmission channels and/or objects, especially moving objects, nearby or in the vicinity of the respective radiofrequency sensing stations, especially in case that user equipments operate (or are able to operate) as radiofrequency sensing stations, it should be assured that unauthorized use of network resources should be avoided as well as interferences reduced.

### SUMMARY

In an exemplary embodiment, the present invention provides a method for conducting radiofrequency sensing involving at least a radiofrequency sensing station as part of a mobile communication network. The method includes: obtaining, by the radiofrequency sensing station, a sensing-related indication, wherein the sensing-related indication indicates whether the radiofrequency sensing station is allowed to conduct sensing or to activate the radiofrequency sensing functionality at its present location; and based on the sensing-related indication, conducting, by the radiofrequency sensing station radiofrequency sensing, wherein conducting the radiofrequency sensing comprises transmitting a radiofrequency sensing signal and/or receiving a radiofrequency sensing reception signal.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates a mobile communication network comprising or interworking with at least one radiofrequency sensing station that is able to activate a radiofrequency sensing functionality and is, hence, able to conduct radiofrequency sensing, wherein the radiofrequency sensing functionality, if activated, is conducted via transmitting a radiofrequency sensing signal and/or via receiving a radiofrequency sensing reception signal.

### DETAILED DESCRIPTION

Exemplary embodiments of the present invention provide a technically simple, effective and cost-effective solution for efficiently conducting radiofrequency sensing involving at least a radiofrequency sensing station as part of a mobile communication network. Further exemplary embodiments of the present invention provide a corresponding system or mobile communication network, radiofrequency sensing station, sensing service node and a corresponding program and computer-readable medium.

In an exemplary embodiment, the present invention provides a method for

conducting radiofrequency sensing involving at least a radiofrequency sensing station as part of a mobile communication network, wherein the radiofrequency sensing station is able to activate a radiofrequency sensing functionality and conduct radiofrequency sensing
via transmitting a radiofrequency sensing signal and/or
via receiving a radiofrequency sensing reception signal,
wherein, in order to conduct the radiofrequency sensing and/or to activate the radiofrequency sensing functionality, the method comprises the following steps:
in a first step, the radiofrequency sensing station receives or generates or determines a sensing-related indication, wherein the sensing-related indication is related to or indicates whether the radiofrequency sensing station is allowed or authorized to conduct sensing or to activate the radiofrequency sensing functionality at its present or current location,
in a second step, the radiofrequency sensing station conducts sensing or activates the radiofrequency sensing functionality, or not, dependent on the sensing-related indication or its content.

It is thereby advantageously possible according to the present invention that radiofrequency sensing is not only able to be performed in a comparatively easy and straight-forward manner, but also that it is possible to control the use of radiofrequency sensing or the activation of the radiofrequency sensing functionality.

Especially, it is advantageously possible, according to the present invention, that the use or activation of the radiofrequency sensing functionality within or as part of user equipments is able to be controlled by mobile communication network (or its operator) based on the location of the radiofrequency sensing stations, i.e. based on the location of the user equipments. Especially, it is thereby advantageously possible, for the mobile communication network, to control the use of network resources and/or the potential generation of a higher level of interference due to radiofrequency sensing activity by user equipments, i.e. the potentially detrimental effects of conducting radiofrequency sensing (in a specific area or at a specific location) in terms or network performance is able to be controlled according to the present invention (e.g. due to conducting radiofrequency sensing requires the use (by user equipments and/or by the respective base station entities in the considered geographical area or location) of air interface resources, or radiofrequency resource blocks, that would otherwise be able to be used for (operational) communication purposes between the user equipments and/or the base station entity and/or due to conducting radiofrequency sensing might generate additional interference in the considered geographical area or location).

Hence, according to the present invention, in order to conduct radiofrequency sensing and/or to activate the radiofrequency sensing functionality (within a radiofrequency sensing station, especially a user equipment), a method comprises that, in a first step, the radiofrequency sensing station receives or generates or determines a sensing-related indication, and, in a second step, that the radiofrequency sensing station conducts sensing or activates the radiofrequency sensing functionality, or not (i.e. deactivates the radiofrequency sensing functionality or refrains from conducting radiofrequency sensing), dependent on the sensing-related indication or its content.

According to the present invention, the sensing-related indication is related to or indicates whether the radiofrequency sensing station is allowed or authorized to conduct sensing or to activate the radiofrequency sensing functionality at its present or current location.

According to different embodiments of the present invention, the sensing-related indication might be different or carry a different information content.

According to a first group of embodiments according to the present invention, the radiofrequency sensing station has or receives a sensing-related location information, wherein the sensing-related location information indicates or is related to where or at which locations or areas the radiofrequency sensing station is allowed or authorized to conduct sensing, or not (i.e. the sensing-related location information indicates or is related to where or at which locations or areas the radiofrequency sensing station is not allowed or not authorized to conduct sensing), and, likewise in or during the first step, the radiofrequency sensing station receives or generates or determines a location information, wherein the location information indicates or is related to the present or current location or position of the radiofrequency sensing station,
and wherein it is the radiofrequency sensing station that determines, based on both the sensing-related location information and on the location information, the sensing-related indication being related to or indicating whether the radiofrequency sensing station is allowed or authorized to conduct sensing or to activate the radiofrequency sensing functionality at its present or current location, or not. Hence, according to this first group of embodiments, it is the entity or functionality sensing station that determines (or generates) the sensing-related information (based on the sensing-related location information and based on the location information that it itself is able to generate or that it receives (i.e. from the mobile communication network, e.g. from the serving base station entity).

According to different embodiments of the first group of embodiments according to the present invention, the sensing-related location information comprises at least one of the following:
an indication of a location-based specific sensing service configuration, indicating locations or geographical areas where sensing or the activation of the radiofrequency sensing functionality is restricted or interdicted and/or locations or geographical areas where sensing or the activation of the radiofrequency sensing functionality is authorized or allowed,
an indication of which networks, especially public land mobile networks, the radiofrequency sensing station is allowed or authorized to perform or conduct sensing or to activate the radiofrequency sensing functionality, wherein especially the sensing-related location information comprises a list of such networks,
an indication of a location-based specific sensing service configuration relating to out-of-coverage situations of the radiofrequency sensing station, indicating locations or geographical areas where sensing or the activation of the radiofrequency sensing functionality is restricted or interdicted in case of an out-of-coverage situation of the radiofrequency sensing station and/or locations or geographical areas where sensing or the activation of the radiofrequency sensing functionality is authorized or allowed.

According to a second group of embodiments according to the present invention, the radiofrequency sensing station receives the sensing-related indication (i.e. as opposed to the first group of embodiments according to the present invention, it is not the radiofrequency sensing station that determines, based on both the sensing-related location information and on the location information, the sensing-related indication, but the radiofrequency sensing station receives the sensing-related indication) via at least one of the following:
upon a request of the radiofrequency sensing station towards a sensing service node of or assigned with the mobile communication network (or an application server), wherein the sensing-related indication is transmitted, by the sensing service node and received by the radiofrequency sensing station, after the radiofrequency sensing station providing a location information, especially as part of the request, of the present or current location or position of the radiofrequency sensing station or after the mobile communication network determining the present or current location or position of the radiofrequency sensing station,
as an information element, especially as part of a system information block, especially transmitted or broadcast by a base station entity (in which case, the (exact) location of the radiofrequency sensing station would, especially, be of limited relevance as such an information element, especially as part of a system information block, would be able to be received on a rather limited geographical area (of the respective radio cell of the base station entity) anyway).

According to the present invention, it is advantageously possible and preferred that, in or during the first step, the radiofrequency sensing station has or receives a sensing-related location information, wherein the sensing-related location information indicates or is related to where or at which locations or areas the radiofrequency sensing station is allowed or authorized to conduct sensing, or not, and, likewise in or during the first step, the radiofrequency sensing station receives or generates or determines a location information, wherein the location information indicates or is related to the present or current location or position of the radiofrequency sensing station,
wherein the radiofrequency sensing station determines, based on both the sensing-related location information and on the location information, the sensing-related indication being related to or indicating whether the radiofrequency sensing station is allowed or authorized to conduct sensing or to activate the radiofrequency sensing functionality at its present or current location, or not.

Thereby, it is advantageously possible to implement a method and system according to exemplary embodiments of the present invention in an especially efficient manner.

According to the present invention, it is advantageously furthermore possible and preferred that the sensing-related location information comprises at least one of the following:
an indication of a location-based specific sensing service configuration, indicating locations or geographical areas where sensing or the activation of the radiofrequency sensing functionality is restricted or interdicted and/or locations or geographical areas where sensing or the activation of the radiofrequency sensing functionality is authorized or allowed,
an indication of which networks, especially public land mobile networks, the radiofrequency sensing station is allowed or authorized to perform or conduct sensing or to activate the radiofrequency sensing functionality, wherein especially the sensing-related location information comprises a list of such networks,
an indication of a location-based specific sensing service configuration relating to out-of-coverage situations of the radiofrequency sensing station, indicating locations or geographical areas where sensing or the activation of the radiofrequency sensing functionality is restricted or interdicted in case of an out-of-coverage situation of the radiofrequency sensing station and/or locations or geographical areas where sensing or the activation of the radiofrequency sensing functionality is authorized or allowed.

Thereby, it is advantageously possible to implement a inventive method and system according to exemplary embodiments of the present invention in an especially efficient manner.

According to another embodiment of the present invention, it is furthermore advantageously possible and preferred that the radiofrequency sensing station receives the sensing-related indication via at least one of the following:
upon a request of the radiofrequency sensing station towards a sensing service node of or assigned with the mobile communication network, wherein the sensing-related indication is transmitted, by the sensing service node and received by the radiofrequency sensing station, after the radiofrequency sensing station providing a location information, especially as part of the request, of the present or current location or position of the radiofrequency sensing station or after the mobile communication network determining the present or current location or position of the radiofrequency sensing station,
as an information element as part of a system information block, especially broadcast by a base station entity.

Thereby, it is advantageously possible to implement a inventive method and system according to exemplary embodiments of the present invention in an especially efficient manner.

Furthermore, it is advantageously possible and preferred according to the present invention that the sensing-related location information and/or the sensing-related indication comprises specific sensing service configuration information, especially an indication of the radio resources allowed to be used for sensing.

It is thereby advantageously possible according to the present invention for the mobile communication network to be able to have an even greater control, or a more fine-granular control, on the manner how the radiofrequency sensing is actually performed. Of course, it is possible according to the present invention that the specific sensing service configuration information is able to differ dependent on where the radiofrequency sensing is (to be) performed: i.e. in a first geographical area or a first location, a first set of sensing parameters might be able or required to be used and in a second geographical area or a second location, a second set of sensing parameters might be able or required to be used.

Furthermore, it is advantageously possible and preferred according to the present invention that the sensing-related location information is transmitted to the radiofrequency sensing station, and received by the radiofrequency sensing station, via at least one of the following:
an over-the-air (OTA) transport mechanism, the OTA transport mechanism especially being initiated by the mobile communication network,
via pre-configuration of the sensing-related location information in a memory location of or within the radiofrequency sensing station, especially within an universal integrated circuit card of the radiofrequency sensing station or within the mobile equipment of the radiofrequency sensing station.

Thereby, it is advantageously possible to implement a method and system according to exemplary embodiments of the present invention in an especially efficient manner.

According to a further preferred embodiment of the present invention the radiofrequency sensing station is or corresponds to a user equipment, wherein the mobile communication network especially corresponds to a home network of the user equipment, especially a public land mobile network or a non-public network.

Thereby, it is advantageously possible to implement a method and system according to exemplary embodiments of the present invention in an especially efficient manner.

Furthermore, the present invention relates to a system or mobile communication network for conducting radiofrequency sensing involving at least a radiofrequency sensing station as part of the mobile communication network, wherein the radiofrequency sensing station is able to be operated such as to activate a radiofrequency sensing functionality and conduct radiofrequency sensing
via transmitting a radiofrequency sensing signal and/or
via receiving a radiofrequency sensing reception signal,
wherein, in order to conduct the radiofrequency sensing and/or to activate the radiofrequency sensing functionality, the system or mobile communication network is configured such that:
a sensing-related indication is transmitted to the radiofrequency sensing station, and received by the radiofrequency sensing station, or generated or determined by the radiofrequency sensing station, wherein the sensing-related indication is related to or indicates whether the radiofrequency sensing station is allowed or authorized to conduct sensing or to activate the radiofrequency sensing functionality at its present or current location, wherein sensing is conducted or the radiofrequency sensing functionality activated, or not, dependent on the sensing-related indication or its content,
wherein the mobile communication network especially corresponds to the a home network, especially a public land mobile network or a non-public network, of the radiofrequency sensing station or user equipment.

Furthermore, the present invention relates to a radiofrequency sensing station being or corresponding to a user equipment in a system or in a mobile communication network, or as a part thereof, according to the present invention.

Furthermore, the present invention relates to a sensing service node in a system or in a mobile communication network, or as a part thereof, according to the present invention.

Additionally, the present invention relates to a program comprising a computer readable program code which, when executed on a computer and/or on a radiofrequency sensing station and/or on a network node of a mobile communication network and/or on a sensing service node of the mobile communication network, or in part on a radiofrequency sensing station and/or in part on a network node of a mobile communication network and/or in part on a sensing service node, causes the computer and/or the radiofrequency sensing station and/or the network node of the mobile communication network and/or the sensing service node to perform a method according to exemplary embodiments of the present invention.

Still additionally, the present invention relates to a computer-readable medium comprising instructions which when executed on a computer and/or on a radiofrequency sensing station and/or on a network node of a mobile communication network and/or on a sensing service node of the mobile communication network, or in part on a radiofrequency sensing station and/or in part on a network node of a mobile communication network and/or in part on a sensing service node, causes the computer and/or the radiofrequency sensing station and/or the network node of the mobile communication network and/or the sensing service node to perform a method according to exemplary embodiments of the present invention.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings, but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

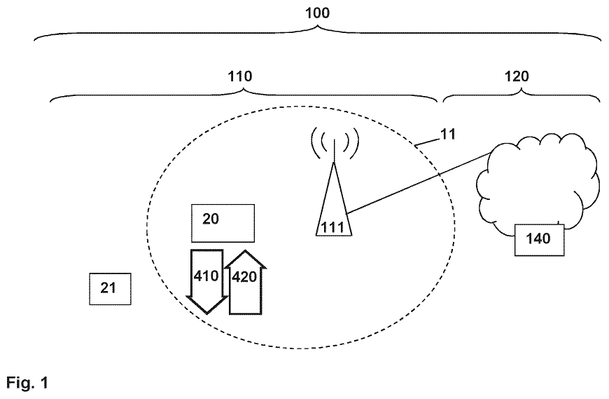

FIG. 1 schematically illustrates a mobile communication network 100 comprising or interworking with at least one radiofrequency sensing station 20 that is able to activate a radiofrequency sensing functionality and is, hence, able to conduct radiofrequency sensing, wherein the radiofrequency sensing functionality, if activated, is conducted via transmitting a radiofrequency sensing signal 410 and/or via receiving a radiofrequency sensing reception signal 420.

According to the present invention, it is preferred (but not mandatorily the case) that the radiofrequency sensing station 20 is or corresponds to a user equipment 20 within or connected to the mobile communication network 100. the user equipment 20 corresponding, e.g. to a smart phone device or a machine type communication device or to a specific sensing user equipment device. The mobile communication network 100, typically, comprises a radio access network 110 as well as a core network 120 (or, at least, the radio access network 110 and/or the core network 120 is assigned to the mobile communication network 100), and the radio access network 110 comprises at least one base station entity 111, such as, especially, a gNB-station, but typically the mobile communication network 100 comprises a plurality of such base station entities. The base station entity 111 has a radio coverage area (or radio cell) indicated via reference sign 11 and a dashed line in FIG. 1. In the exemplary situation represented in FIG. 1, the radiofrequency sensing station 20 (or the user equipment 20) is shown being located within radio cell 11, and another radiofrequency sensing station 21 (or other user equipment 21) is shown being located outside of radio cell 11, i.e. out of coverage with regard to base station entity 111. In the exemplary embodiment shown in FIG. 1, the telecommunications network 100, especially the core network 120, comprises a sensing service node 140, especially being involved or being used to control the activation or deactivation of the sensing functionality of the radiofrequency sensing stations 20, 21, typically based on their respective location.

It might be the case that the radiofrequency sensing reception signal 420 is received, by the radiofrequency sensing station 20, as a result of the radiofrequency sensing signal 410 being transmitted by the same radiofrequency sensing station 20 (this situation is schematically hinted at via two arrows with reference signs 410 and 420, respectively); however, it might also be the case that the radiofrequency sensing reception signal 420 is received, by the radiofrequency sensing station 20, as a result of another radiofrequency sensing signal being transmitted by another radiofrequency sensing station 21 (schematically also shown in FIG. 1, the other radiofrequency sensing station 21 being depicted not having radio coverage provided by the base station entity 111, i.e. outside of radio cell 11.

While it is possible that the radiofrequency sensing station 20 transmits the radiofrequency sensing signal 410 in a direction-dependent manner (e.g. by using active antenna technology, e.g. beamforming antennas, such as to achieve an angular resolution or variation of the transmission power with regard to the radiofrequency sensing signal 410), FIG. 1 primarily shows, as one exemplary implementation, the rather classical transmission of the radiofrequency sensing signal 410 in various directions.

The radiofrequency sensing signal 410 might correspond to a direct transmission (or direct path-transmission) of the radiofrequency sensing signal 410 between different sensing stations 20, 21 but it could also correspond to a transmission of the radiofrequency sensing signal 410 towards or in the direction of another object in the vicinity of the radiofrequency sensing stations 20, 21, e.g. a moving object such as a vehicle, a drone or the like. All those possibilities (of the radiofrequency sensing signal being transmitted between radiofrequency sensing stations 20, 21 and/or involving only one radiofrequency sensing station 20) might also (and will in many circumstances) be realized cumulatively, i.e. the radiofrequency sensing signal 410 is transmitted (e.g. by radiofrequency sensing station 20), and, as a consequence or result thereof, the radiofrequency sensing reception signal 420 is received by either the radiofrequency sensing station 20 or the further radiofrequency sensing station 21 (or vice versa)—however, for the sake of simplicity, this is not explicitly shown in FIG. 1.

In the context of the present invention. the terms radiofrequency sensing signal 410 and radiofrequency sensing reception signal 420 are used in order to indicate that a (radiofrequency) signal (i.e. the radiofrequency sensing signal 410), once transmitted by the radiofrequency sensing station 20 (or transmitted by the other radiofrequency sensing station 21). is necessarily altered (such as distorted, attenuated, reflected or the like), and, hence, arrives (or is received) as an at least somehow or somewhat different (radiofrequency) signal (i.e. the radiofrequency sensing reception signal 420) at the reception side. i.e. either the same radiofrequency sensing station 20 (i.e. the one having transmitted the radiofrequency sensing signal) or the other radiofrequency sensing station 21. However, the radiofrequency sensing reception signal 420 is not inherently different from the radiofrequency sensing signal 410, but carries the signal modifications having occurred while being propagated between its transmission and its reception (by whichever radiofrequency sensing station 20, 21).

Thus, according to the present invention, a method for conducting radiofrequency sensing involves at least a radiofrequency sensing station 20 as part of a mobile communication network 100. The radiofrequency sensing station 20 (and as well the other radiofrequency sensing station) is able to activate a radiofrequency sensing functionality and conduct radiofrequency sensing via transmitting a radiofrequency sensing signal 410 and/or via receiving a radiofrequency sensing reception signal 420. In order to conduct such radiofrequency sensing and/or to activate the radiofrequency sensing functionality, the method comprises the steps of:
in a first step, the radiofrequency sensing station 20 receives or generates or determines a sensing-related indication, wherein the sensing-related indication is related to or indicates whether the radiofrequency sensing station 20 is allowed or authorized to conduct sensing or to activate the radiofrequency sensing functionality at its present or current location,
in a second step, the radiofrequency sensing station 20 conducts sensing or activates the radiofrequency sensing functionality, or not (i.e. it does not conduct sensing or it deactivates the radiofrequency sensing functionality), dependent on the sensing-related indication or its content.

According to the present invention. it is thereby advantageously possible to conduct (or to activate, or, rather, to deactivate) radiofrequency sensing (or a radiofrequency sensing functionality) based on the location of the radiofrequency sensing station 20, 21. Especially, thereby it is possible to implement a control of the mobile communication network (i.e. of the network operator thereof) to have a greater or even full control on the radiofrequency sensing behavior of radiofrequency sensing stations 20, 21, especially user equipments 20 21. Especially, it is thereby advantageously possible to interdict user equipments 20, 21 to use network resources or spectrum without authorization (of the mobile communication network 100 or its network operator). From the point of view of a mobile network operator, it might be important to have possibilities to avoid unauthorized use of network resources (especially the use of radiofrequency spectrum, especially licensed spectrum, or radiofrequency air interface resources) and to reduce interference between user equipments and preserve enough resources for communication. Hence, it is advantageously possible, according to the present invention that—in a certain geographical area—certain radio resources are currently not occupied by communication and, hence, might successfully and beneficially be used for sensing purposes, while-in certain other parts of the network—there could be the expectation of a higher traffic load and, hence, sensing could be restricted; thereby, the protection of communication resources of the mobile communication network is possible to be realized.

According to the present invention. the mobile communication network 100 (or its operator) can control the network resources based on the location of the radiofrequency sensing stations 20, i.e. based on the location of the user equipments 20, 21, and can configure and re-configure user equipments 20, 21, e.g. via over-the-air mechanisms, OTA mechanisms. The user equipments 20, 21 are preferably preconfigured with a saved information, e.g. in user equipment memory. When switched on, the user equipment 20, 21 could, e.g., load or use a specific sensing configuration based on (its) location. According to the present invention, it is furthermore possible that sensing can also be used out of coverage (i.e. in case that a user equipment 21 is out of coverage regarding the mobile communication network 100) and respectively it is also possible that a user equipment 20, 21 (or radiofrequency sensing station 20, 21) is controlled without having network coverage.

According to preferred embodiments of the present invention, the home network of the user equipment 20, 21 (especially a home public land mobile network, HPLMN) pre-configures (e.g. via a configurations server or a sensing service function or sensing service node 140) the user equipment 20, 21 (as radiofrequency sensing station 20, 21) with an authorization information for a list of networks (or public land mobile networks, PLMNs) where the user equipment 20, 21 is authorized to perform radiofrequency sensing or to be part of the radiofrequency sensing service.

Especially, the home network (or HPLMN) pre-configures the user equipment 20, 21 with location based specific sensing service configuration as in some locations radiofrequency sensing is likely to be restricted while in others it is allowed.

Especially, the home network or HPLMN pre-configures the user equipment 20, 21 with “out of coverage” use of sensing based on location.

When the user equipment 20, 21 is switched on, or declares starting using radiofrequency sensing services (i.e. activates its radiofrequency sensing functionality in order to conduct radiofrequency sensing), it preferably determines its location via different possible ways (e.g. via a global navigation satellite system such as GPS and/or via the network location and/or the specific tracking area, TA, obtained via user equipment registration) and, based on this location, the user equipment 20, 21 loads specific configuration from user equipment memory (saved, e.g., in advance in the user equipment terminal (mobile equipment, ME) or in the UICC). If there is a lack of specific configuration for a specific location where the user equipment 20, 21 is, the user equipment 20, 21 might use default configuration for sensing service.

Furthermore especially, the home network or HPLMN might be able to re-configure these settings, e.g. due to a planned change of configurations regarding, e.g., all user equipments, e.g. via over-the-air (OTA) mechanisms.

When received by the user equipment 20, 21, such information (provided by the home network) are able to be saved in the user equipment's memory (ME, USIM) and used further when needed and whenever the user equipment 20, 21 is in this area. This also includes the use of specific radiofrequency signals to be used and/or the use of specific spectrum or specific radiofrequency air interface resources—i.e. which frequency band, how many user equipments 20, 21 can be part of such service and up to what distance, which specific measurements the user equipment 20, 21 can perform for sensing.

Alternatively, according to other embodiments of the present invention, the user equipment 20, 21 might first connect to the sensing service node 140 in order to receive configurations if and how to use the radiofrequency sensing service in the respective area where such radiofrequency sensing services are currently available. Such configuration or configuration information might be received via an application programming interface (API) or via non-access stratum (NAS) communication (alternatively to OTA mechanism), e.g. from the sensing service node 140 as a specific configuration server, and after the respective (considered) user equipment 20, 21 has contacted it. When the user equipment 20, 21 is switched on or when the user equipment 20, 21 declares starting using the radiofrequency sensing service, user equipment 20, 21 has to request from the network (configuration server or sensing service node 140) specific sensing service configuration and radio resources allowed to be used for radiofrequency sensing. The user equipment 20, 21 might either send its location, or the mobile communication network 100 might check the user equipment's location, and based on it send specific configuration for this area, i.e. the respective area where the considered respective user equipment 20, 21 is located. Such configuration server/sensing function (i.e. the sensing service node 140 or a sensing service entity or functionality) is able to be either a network function or an application function; however, such a transmission of configuration information requires the user equipment 20, 21 (at least at the point in time of this transmission) to have network coverage.

While subject matter of the present disclosure has been illustrated and described in detail in the drawings and foregoing description. such illustration and description are to be considered illustrative or exemplary and not restrictive. Any statement made herein characterizing the invention is also to be considered illustrative or exemplary and not restrictive as the invention is defined by the claims. It will be understood that changes and modifications may be made. by those of ordinary skill in the art. within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for conducting radiofrequency sensing involving at least a radiofrequency sensing station as part of a mobile communication network, the method comprises:
obtaining, by the radiofrequency sensing station, a sensing-related indication, wherein the sensing-related indication indicates whether the radiofrequency sensing station is allowed to conduct sensing or to activate the radiofrequency sensing functionality at its present location; and
based on the sensing-related indication, conducting, by the radiofrequency sensing station radiofrequency sensing wherein conducting the radiofrequency sensing comprises transmitting a radiofrequency sensing signal and/or receiving a radiofrequency sensing reception signal.

2. The method according to claim 1, further comprising:
obtaining, by the radiofrequency sensing station, location information. wherein the location information indicates the present location of the radiofrequency sensing station; and
determining, by the radiofrequency sensing station,. based on the location information and further sensing-related location information indicating where the radiofrequency sensing station is allowed to conduct sensing. whether the radiofrequency sensing station is allowed to conduct sensing at the present location.

3. The method according to claim 1, wherein the sensing-related location information comprises at least one of the following:
an indication of a location-based specific sensing service configuration, indicating locations where sensing is restricted and/or locations where sensing is allowed;
an indication of which networks the radiofrequency sensing station is allowed or to conduct sensing; or
an indication of a location-based specific sensing service configuration relating to out-of-coverage situations of the radiofrequency sensing station, indicating locations where sensing is restricted in case of an out-of-coverage situation of the radiofrequency sensing station and/or locations where sensing is allowed.

4. The method according to claim 1, wherein the radiofrequency sensing station obtains the sensing-related indication via a request of the radiofrequency sensing station towards a sensing service node of the mobile communication network; and/or
wherein the radiofrequency sensing station obtains the sensing-related indication as an information element.

5. The method according to claim 1, wherein the further sensing-related location information and/or the sensing-related indication comprises specific sensing service configuration information..

6. The method according to claim 1, wherein the further sensing-related location information is transmitted to the radiofrequency sensing station and received by the radiofrequency sensing station via at least one of the following:
over-the-air (OTA) transport mechanism; or
pre-configuration of the further sensing-related location information in a memory location of the radiofrequency sensing station.

7. The method according to claim 1, wherein the radiofrequency sensing station corresponds to a user equipment.

8-12 (canceled)

13. A radiofrequency sensing station for conducting radiofrequency sensing, comprising:
a processor; and
a memory having processor-executable instructions stored thereon;
wherein the processor is configured to execute the processor-executable instructions to facilitate the following being performed by the radiofrequency sensing station:
obtaining, by the radiofrequency sensing station, a sensing-related indication, wherein the sensing-related indication indicates whether the radiofrequency sensing station is allowed to conduct sensing or to activate the radiofrequency sensing functionality at its present location; and
based on the sensing-related indication, conducting, by the radiofrequency sensing station radiofrequency sensing, wherein conducting the radiofrequency sensing comprises transmitting a radiofrequency sensing signal and/or receiving a radiofrequency sensing reception signal.

14. A non-transitory computer-readable medium of a radiofrequency sensing station having processor-executable instructions stored thereon for conducting radiofrequency sensing, wherein the processor-executable instructions, when executed, facilitate performance of the following:
obtaining, by the radiofrequency sensing station, a sensing-related indication, wherein the sensing-related indication indicates whether the radiofrequency sensing station is allowed to conduct sensing or to activate the radiofrequency sensing functionality at its present location; and
based on the sensing-related indication, conducting, by the radiofrequency sensing station radiofrequency sensing, wherein conducting the radiofrequency sensing comprises transmitting a radiofrequency sensing signal and/or receiving a radiofrequency sensing reception signal.
